(19) United States
(12) Patent Application Publication
(10) Pub. No.: US 2022/0134719 A1
(43) Pub. Date: May 5, 2022

(54) MECHANICALLY RECYCLABLE BARRIER LAMINATES FOR MAKING FLEXIBLE PACKAGING AND METHODS OF RECYCLING FLEXIBLE PACKAGES FORMED OF RECYCLABLE BARRIER LAMINATES

(71) Applicant: Fres-co System USA, Inc., Telford, PA (US)

(72) Inventor: Jeffrey Scott Beer, Coopersburg, PA (US)

(21) Appl. No.: 17/496,153

(22) Filed: Oct. 7, 2021

Related U.S. Application Data
(60) Provisional application No. 63/107,082, filed on Oct. 29, 2020.

(51) Int. Cl. B32B 27/08; B32B 7/12; B32B 27/32; B32B 27/30; B32B 1/00; B65D 75/58; B65D 77/22; B65D 75/26; B02C 23/20

(52) U.S. Cl. CPC B32B 27/08; B32B 2307/7166; B32B 27/32; B32B 27/306; B32B 1/00; B65D 75/5855; B65D 77/225; B65D 75/26; B02C 23/20; B32B 2553/00; B32B 2307/7244; B32B 2307/514; B32B 2307/732; B32B 2439/46; B32B 2255/10; B32B 2255/205; B32B 7/12

(57) ABSTRACT

Disclosed are recyclable flexible package and a method of recycling such packages. The flexible package includes a hollow body defining an interior chamber for holding an oxygen sensitive product. The body is formed of a laminated film formed of two layers of a single polymer material, e.g., polyethylene, and at least one interposed barrier layer, e.g., polyvinyl alcohol, that is resistant to the passage of oxygen therethrough and which is water-soluble. The single polymer constitutes at least 95% by weight of the laminated film, whereupon the package is suitable for recycling without requiring separation of the materials thereof by shredding the laminated film and subjecting those pieces to an aqueous wash to dissolve the barrier layer.

### CROSS-REFERENCE TO RELATED APPLICATIONS

This utility application claims the benefit under 35 U.S.C. § 119(e) of Provisional Application Ser. No. 63/107,082 filed on Oct. 29, 2020 entitled Mechanically Recyclable Barrier Laminates for Making Flexible Packaging and Methods of Recycling Flexible Packages Formed of Recyclable Barrier Laminates. The entire disclosure of this provisional application is incorporated by reference herein.

### BACKGROUND OF THE INVENTION

### Field of Invention

This invention relates generally to flexible packages, and more particularly to flexible barrier laminates for making flexible packages that can be readily recycled and methods of recycling such flexible packages.

### Description of Related Art

Flexible packages formed of sheet materials have been used for many years and have wide acceptance for holding various products, e.g., roasted coffee and other foodstuffs. Such packages are typically constructed so that they form a high barrier to oxygen to protect the contents of such packages from the ravages of oxygen. For example, high barrier packages for products, such as coffee, are typically composed of layers of dissimilar materials such as a combination of polyester, aluminum foil and polyethylene. That construction performs very well for coffee preservation. There have been recent developments in recyclable packaging using about 95% of one polymer for the package construction.

The multilayer mixed plastic and metal composition is currently unable to be recycled because its individual components cannot be separated from one another. The current 95% mono-plastic material can be recycled. However, the remaining 5% of barrier materials, inks and adhesives cannot be separated and therefore must be incorporated into the reclaimed plastic. This leaves undesirable colors and incompatible materials detrimental to the quality of the reclaimed plastic.

Accordingly, a need exists for a high oxygen barrier flexible laminate for packages that can be readily recycled. The subject invention addresses that need by providing a high oxygen barrier flexible laminate for packages that allows for easier recycling of the package produced therefrom since there is no need to separate its individual layers and components and for methods for recycling such packages.

### SUMMARY OF THE INVENTION

One aspect of this invention is a flexible barrier laminate for making packages to preserve oxygen sensitive products by blocking atmospheric oxygen transmission through the flexible barrier laminate. The flexible barrier laminate is formed of a single polymer, a first polymer layer, a second polymer layer and a first oxygen-barrier layer. The first polymer layer and the second polymer layer are each formed of the single polymer. The first oxygen-barrier layer is water-soluble and is interposed between the first polymer layer and the second polymer layer. The second polymer layer is adhesively secured to the first polymer layer and makes up a minimum of approximately 95% by weight of the flexible barrier laminate. The second polymer layer is configured to be separated from the first polymer layer by the application of an aqueous wash to the flexible barrier laminate to cause the first oxygen-barrier layer to dissolve.

In accordance with one preferred aspect of the flexible barrier laminate of this invention, the first polymer layer comprises oriented polyethylene.

In accordance with another preferred aspect of the flexible barrier laminate of this invention, the first polymer layer is oriented and the second polymer layer is unoriented.

In accordance with another preferred aspect of the flexible barrier laminate of this invention, the first oxygen-barrier layer is polyvinyl alcohol.

In accordance with another preferred aspect of the flexible barrier laminate of this invention, the second polymer layer is adhesively secured to the first polymer layer by a an adhesive material layer interposed between the first polymer layer and the second polymer layer. The first oxygen-barrier layer is interposed between the first polymer layer and the adhesive material layer, and a second oxygen-barrier layer is interposed between the adhesive material layer and the second polymer layer. The second oxygen-barrier layer is water-soluble.

In accordance with another preferred aspect of the flexible barrier laminate of this invention, the first oxygen-barrier layer is polyvinyl alcohol and the second oxygen-barrier layer is polyvinyl alcohol.

In accordance with another preferred aspect of the flexible barrier laminate of this invention, the adhesive material layer comprises polyester-urethane adhesive.

In accordance with another preferred aspect of the flexible barrier laminate of this invention, the flexible barrier laminate additionally comprises a layer of printing ink between the first polymer layer and the second polymer layer.

In accordance with another preferred aspect of the flexible barrier laminate of this invention, the first polymer layer is polyethylene and is approximately 25 microns in thickness, the second polymer layer is polyethylene and is approximately 75 microns in thickness, and the first and second layers of polyvinyl alcohol are each 0.5 microns in thickness.

In accordance with another preferred aspect of the flexible barrier laminate of this invention, the flexible barrier laminate forms the body of a flexible package. The flexible package has an interior chamber configured to hold an oxygen sensitive product therein.

In accordance with another preferred aspect of the flexible barrier laminate of this invention, the body includes a mouth formed by abutting portions of the flexible barrier laminate. The mouth includes a peelable seal material layer interposed between the abutting portions of the flexible barrier laminate. The mouth is configured to be peeled open to provide access to the oxygen sensitive product within the interior chamber.

In accordance with another preferred aspect of the flexible barrier laminate of this invention, the first polymer layer is polyethylene and is approximately 25 microns in thickness, the second polymer layer is polyethylene and is approximately 75 microns in thickness, the first and second layers of polyvinyl alcohol are each 0.5 microns in thickness, and the peelable seal material is approximately 2 microns in thickness.

In accordance with another preferred aspect of the flexible barrier laminate of this invention, the flexible barrier laminate additionally comprises a layer of aluminum.

In accordance with another preferred aspect of the flexible barrier laminate of this invention, the flexible package additionally comprises a degassing valve mounted on the body of the flexible package and in fluid communication with the interior chamber.

Another aspect of this invention is method of recyclable a flexible package. The method comprises providing a discarded flexible package having a body resistant to atmospheric oxygen transmission therethrough. The hollow body is formed of a flexible laminated barrier comprising a first polymer layer formed of the single polymer, a second polymer layer formed of the single polymer, and a first oxygen-barrier layer. The first oxygen-barrier layer is water-soluble and interposed between the first polymer layer and the second polymer layer. The second polymer layer is adhesively secured to the first polymer layer and makes up a minimum of approximately 95% by weight of the flexible barrier laminate. The second polymer layer is configured to be separated from the first polymer layer by the application of an aqueous wash to the flexible barrier laminate. The discarded flexible package is into shredded pieces of the flexible barrier laminate. The shredded pieces are subjected to an aqueous wash, whereupon the aqueous wash dissolves the oxygen-barrier layer, thereby producing pieces of the first polymer layer and pieces of the second polymer layer. The pieces of the first polymer layer and second polymer layer are recovered from the aqueous wash and from any other materials of the discarded flexible package that may result from the action of the aqueous wash on the shredded pieces.

In accordance with one preferred aspect of the method of this invention the flexible laminated barrier includes a layer of an adhesive.

In accordance with another preferred aspect of the method of this invention the flexible laminated barrier includes at least one of a layer of a printing ink and a layer of aluminum.

In accordance with another preferred aspect of the method of this invention the first polymer material comprises polyethylene.

In accordance with another preferred aspect of the method of this invention the oxygen-barrier layer comprises polyvinyl alcohol.

In accordance with another preferred aspect of the method of this invention the laminated barrier additionally comprises an adhesive.

In accordance with another preferred aspect of the method of this invention the laminated barrier additionally comprises at least one of a printing ink and a layer of aluminum.

In accordance with another preferred aspect of the method of this invention the adhesive comprises polyester-urethane.

### DESCRIPTION OF THE DRAWING

The invention will be described in conjunction with the following drawings in which like reference numerals designate like parts and wherein:

FIG. 1 is an isometric view of one exemplary recyclable flexible package constructed in accordance with this invention;

FIG. 2 is a highly enlarged, but not to scale, cross sectional view taken along line 2-2 of FIG. 1 showing the construction of the barrier lamination making up the body of the recyclable flexible package shown in FIG. 1;

FIG. 3 is also a highly enlarged, but not to scale, cross sectional view taken along line 3-3 of FIG. 1 showing the construction of the peelable mouth of the recyclable flexible package shown in FIG. 1;

FIG. 4 is a highly enlarged, but not to scale, cross sectional view taken along line 4-4 of FIG. 1 showing the construction of the degassing valve forming a portion of the recyclable package of FIG. 1;

FIG. 5 is a block diagram illustrating a method of recycling the polymer material making up the flexible package shown in FIG. 1, or any other single polymer flexible package constructed in accordance with this invention; and

FIG. 6 is a highly enlarged, but not to scale, cross sectional view, similar to FIG. 2, showing the construction of an alternative barrier film constructed in accordance with this invention for making up a body of the recyclable flexible package constructed in accordance with this invention.

### DETAILED DESCRIPTION OF THE PREFERRED EMBODIMENT

Referring now to the various figures of the drawing wherein like reference characters refer to like parts, there is shown in FIG. 1 one exemplary embodiment of a recyclable flexible package 20 constructed in accordance with this invention. As will be described in detail later, the flexible package is formed of flexible barrier laminate (laminated film) 10 composed of plural layers formed single polymer. The term “single polymer” means that only one type of polymer is included in the layers making up the flexible barrier laminate or film 10. The single polymer of the exemplary film 10, which will be described hereinafter is polyethylene, inasmuch as recycling of polyethylene is a common practice in the United States. However, the film 10 making up the package 20 can be composed of other single polymers, e.g., polypropylene, polyester, etc., if recycling of those polymers becomes desirable or commercially feasible or otherwise desirable.

In any case, the flexible package 20 includes an interior chamber 12 (FIG. 4) for holding an oxygen sensitive product 14, e.g., coffee beans, ground coffee, etc., to preserve that product by blocking atmospheric oxygen transmission through the walls of the package. The exemplary package 20 shown in FIG. 1 is in the form of a gusseted bag 22 that formed of the flexible barrier laminate or film 10. That laminated film includes at least one layer, to be described later, which forms a barrier to the passage of oxygen from the ambient atmosphere into the interior chamber of the bag. A pressure-equalizing, one-way degassing valve 24 is mounted on the bag's front wall to enable gases produced by the coffee within the bag to exit the bag through the valve 24.

It should be noted at this point that while the bag 22 is shown in the form of a gusseted bag, it may be of other shapes or constructions and still be within the scope of this invention. By way of example, but not limitation, the bag portion of a package constructed in accordance with this invention may be in the form of a so-called “pillow bag”, a “stand-up pouch” or any other type or style of flexible package. What is important is the polymer material making up the package be of the same type, so that the package needn't be separated for recycling. To that end, as will be described in detail later the bag 22 is formed of a laminated film material which by weight is essentially, e.g., at least 95% by weight, one type of thermoplastic polymer, e.g., polyethylene, with the valve, if used, being formed of the same type of polymer.

As best seen in FIG. 1, the gusseted bag 22 basically comprises a front wall or panel 22A, a rear wall or panel 22B, a pair of identical opposed gusseted side walls or panels 22C, a top end portion 22D, and a bottom end portion 22E. The top end portion of the bag terminates in a top marginal edge, while the bottom end portion terminates in a bottom marginal edge. The degassing valve 24 is mounted in the front panel 22A, although it can be located in the rear panel as well, and is in communication with the interior of the bag, which is in the form of the hollow chamber 12 for holding an oxygen-sensitive product, e.g., coffee 14, therein. The valve 24 enables gasses which may be produced by the material(s) (e.g., coffee 14) contained within the chamber 12 after the bag is hermetically sealed to vent to the ambient air, without air gaining ingress to the bag's chamber.

In the exemplary embodiment of the package 20 the front panel 22A, rear panel 22B, and the two gusseted sides 22C of the bag are all integral portions of a single sheet or web of the flexible film 10 which has been folded and seamed to form a tubular body. The package has a peelable mouth formed by a line 22F of conventional peelable seal material, e.g., ethylene vinyl acetate copolymer, located on portions of the inner surface of the walls of the bag adjacent, e.g., slightly below, its top marginal edge and extending across the width of the front and rear panels and the interposed gusseted sides as best seen in FIGS. 1 and 3. The peelable seal line 22F enables the walls of the bag to be readily peeled apart to open the mouth to provide access to the product held within the interior of the bag. The package 20 is arranged to be initially hermetically sealed along the peelable seal line 22F after it has been filled and vacuumized.

The lower or bottom end of the bag 22 is sealed closed along a transverse, permanent seam line (not shown) closely adjacent the bottom edge. The permanent seam line is formed using any conventional sealing technique. When the bag 22 is filled, vacuumized, and sealed its particulate contents, e.g., coffee, will be kept isolated from the ambient air by the material barrier properties of the laminated film 10 making up the bag 22.

The degassing valve 24 is best seen in FIG. 4 and is constructed similar to the valve of U.S. Pat. No. 5,893,461, whose disclosure is specifically incorporated herein, and basically comprises a cap 26, a base 28, a movable valve member or septum 30, and a filter member 32. The cap and base when connected together form the housing of the valve. The septum 30 is in the form of a flexible disk, which is located within the housing. The cap 26 is a generally cylindrical member having a planar circular top wall 26A and a circular slightly conical side wall 26B terminating at its bottom in an under-cut annular groove 26C. The base member 28 is a generally cup-shaped member having a planar circular bottom wall 28A and a circular sidewall 28B terminating at its top in an annular flange 28C. The bottom wall 28A includes a central opening or hole 28D having an annular flange extending thereabout and projecting up from the interior surface of the bottom wall 28A. The annular flange is under-cut on its exterior surface to be received in and mate with, e.g., snap-fit in, the under-cut groove 26C in the cap 26 to connect the cap to the base and thereby complete the valve's housing.

The entrance to the central opening or hole 28D in the base 28 is located at the bottom of the bottom wall 28A and is enlarged to form a ledge on which the filter member 32 is disposed and secured, e.g., glued. The top surface of the base surrounding the central opening or hole 28D is planar and forms the valve seat 28E of the valve. A thin layer of polydimethylsiloxane (silicone oil) 34 is interposed between the disk 30 and the valve seat 28E. As is known, the presence of the oil 34 interposed between the septum and the valve seat serves an engagement enhancing liquid which forms an elastic bond to enhance the engagement of the septum on the valve seat when the valve is in its normally closed state.

The flange 28C of the base serves as the means to secure the valve 24 to the front panel or wall 22A of the package 20. To that end, the valve's flange 28C is welded or heat-sealed about its entire top surface to the inner surface of the front wall 22A. A pair of small apertures or holes 36 is provided in the front wall of the bag within the bounds of the seal line extending around the flange 26C. Those apertures are in fluid communication with the interior of the valve located above the septum 30. The valve is configured to be in a normally closed state, whereupon the underside of the septum 30 contiguous with its outer periphery is in engagement with the valve seat 28E via the interposed oil 34 to thereby close off the opening or hole 28D and thus isolate the interior of the bag from the ambient atmosphere.

As will be appreciated by those skilled in the art, when the pressure in the interior chamber 12 of the bag is higher than the pressure of the ambient air surrounding the package, as may occur when the coffee within the package degasses, the higher internal pressure will break the elastic bond between the valve seat, the oil 34, and the septum 30, allowing the gas within the package to escape in the direction of arrows shown in FIG. 4 out of the valve and through the holes 36 in the front panel of the bag.

In accordance with a preferred embodiment of this invention the cap 26 and base 28 are injection molded of polyethylene, the disk 30 is stamped from a sheet of polyethylene and the filter member 32 comprises a circular disk of non-woven polyethylene. As such one exemplary valve 24 constructed in accordance with this invention is composed of approximately 938 milligrams of polyethylene and 6 milligrams of silicone oil, so that the valve constitutes approximately 99% polyethylene by weight.

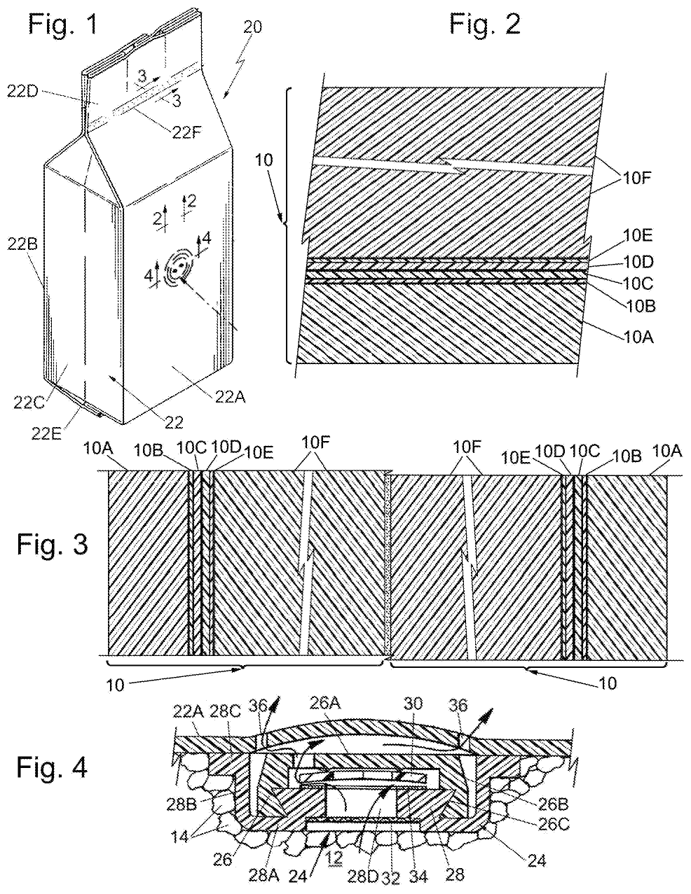

Turning now to FIG. 2 the details of one exemplary laminated film 10 constructed in accordance with this invention to produce the bag 22 will now be described. To that end, the laminated film 10 is constructed and produced as follows. A layer 10A of oriented polyethylene having a thickness of approximately 25 microns is first coated with a layer 10B of polyvinyl alcohol having a thickness of approximately 0.5 microns. Next, an optional layer 10C of printing ink(s) is/are applied over the polyvinyl alcohol to decorate the package. Next, a layer 10D of polyester-urethane adhesive having a thickness of approximately 3 microns is applied over the printing ink layer 10C, if that layer is used. If the laminated film does not include a layer of printing ink(s), the polyester-urethane adhesive layer 10D is applied over the polyvinyl alcohol layer 10B. Next a second layer 10E of polyvinyl alcohol having a thickness of approximately 0.5 microns is applied over the adhesive layer 10D. Lastly a layer of unoriented polyethylene 10E having a thickness of approximately 75 microns is applied over the polyvinyl alcohol layer 10D to complete the laminated film 10, which is then wound onto a roll or coil (not shown).

The coil of laminated film can then be allowed to cure for 5-7 days and then converted into the exemplary gusseted package 22 or any other type of flexible package, with the non-oriented polyethylene of layer 10F forming the inner surface of the bag 22. As mentioned above, the inside of the bag may include a peelable seal material at its mouth to enable the mouth to be peeled open. The peelable seal material is in the form of a coating layer applied in a narrow line 22F to the area of the laminated film 10 which will form the mouth of the bag. The peelable coating can be made of a variety of known peelable coating materials, e.g., ethylene vinyl acetate copolymer, and is only applied to about 10% of the exposed side of the oriented polyethylene layer, is approximately 5 microns thick in the coated area and can be applied to the non-oriented polypropylene layer 10F just prior to the formation of the bag, or during the formation of the bag. FIG. 3 shows the peelable seal material

It should be noted at this juncture that the single polymer layer 10A is preferably oriented, e.g., biaxially or monoaxially, so that it can be readily printed with ink using a conventional printing, e.g., rotogravure, process. However, the layer 10A can, if desired, be non-oriented (unoriented) and yet still be suitable for being printed, if the bag is to bear printing. If the bag or package is not to bear any printing the flexible film making up that bag or package will not include the ink layer 10C.

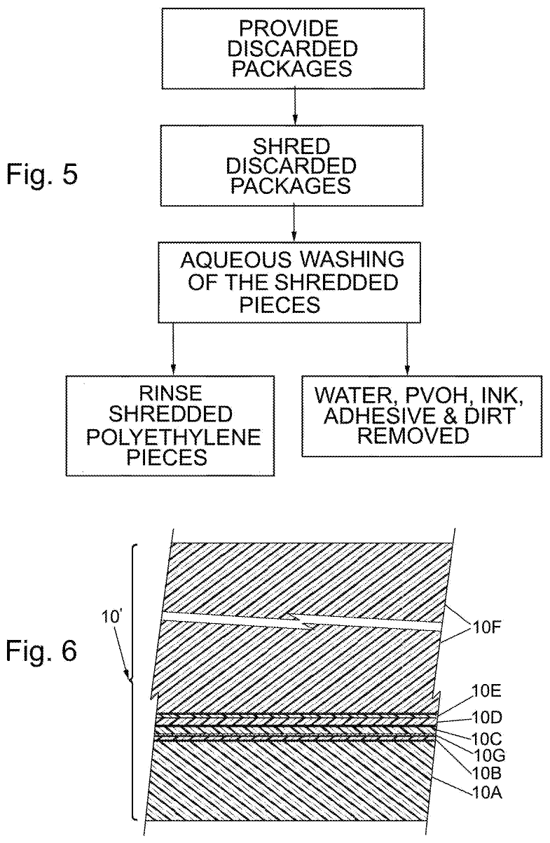

In FIG. 6 there is shown an alternative laminated film 10′ constructed in accordance with this invention. The film 10′ is constructed similarly to the film 10′. Thus the layers of laminated film 10′ which are common to the layers of the laminated film 10 will be given the same reference numbers, and the details of their construction and operation and will not be reiterated in the interest of brevity. However, as can be seen clearly in FIG. 5, the laminated film 10′ includes an optional layer 10G of aluminum that is located between the layers 10C and 10B and is preferably applied over the layer 10B by vapor deposition. In accordance with a preferred embodiment of this invention the aluminum layer is approximately 0.01 microns thick.

Flexible packages constructed in accordance with this invention preferably constitute at least 95% by weight of the single polymer, e.g., polyethylene, so that those packages can be recycled without necessitating separating their various plies or layers of the bags or separating the valves from the bags. Moreover, the flexible packages of this invention will still provide excellent resistant to the passage of oxygen therethrough. In this regard, barrier to oxygen of the composite material making up the laminated film of the package this invention has been measured in a laboratory per ASTM D3985 at 0.02 cc/(100 square inches−24 hours) at 23 degrees C. and 0% RH.

It must be pointed out at this juncture that the exemplary laminated films as described above are mere some examples of laminated films that can be used to make recyclable flexible packages in accordance with this invention, Thus, such films may make use of more or less layers or plies of various types of materials so long as the laminated film is composed of at least 95% by weight of a single type of thermoplastic material. Moreover, any type or construction of a degassing valve can be used, and need not be constructed like the exemplary valve 24 described above so long as the valve is formed of the same type of polymer as that used in the laminated film and whereby the polymer material constitutes at least 95% by weight of the recyclable flexible package.

Turning now to FIG. 5 one method for reclaiming the single polymer of flexible packages constructed in accordance with this invention will now be described. In particular, after such packages have been used for their intended purposes and have been discarded, the discarded packages are collected. The collected discarded packages are then shredded in a conventional manner. Once shredded the shredded pieces of the flexible barrier laminate or film 10 making up the discarded packages are introduced into a tank where they are washed with a heated aqueous solution. The heated aqueous solution is like that used in conventional plants or facilities for recycling polyethylene and includes caustic soda, and may also include a conventional detergent, such as TSP, trisodium phosphate, in water. As should be appreciated by those skilled in the art the heated aqueous solution will dissolve the polyvinyl alcohol layers 10B and 10E of the shredded pieces of the film 10, whereupon the oriented polyethylene layer 10A of the shredded pieces will separate from the non-oriented polyethylene layer 10D. In particular, the shredded pieces of polyethylene, and the polyethylene degassing valve (if a part of the discarded flexible package) will float to the surface of the aqueous solution since polyethylene is lighter than water. Those pieces of the polyethylene can then be drained from the aqueous solution, whereupon they are then rinsed with clear water to result in clean shredded polyethylene pieces. Those clean polyethylene pieces are now suitable for processing into new polyethylene products. The aqueous solution itself, with the polyvinyl alcohol, the ink (if used in the laminated film of the package), the adhesive, the aluminum (if used in the laminated film of the package) and any dirt or debris that may have been on the shredded pieces of the discarded package can then be disposed of or otherwise treated.

While the invention has been described in detail and with reference to specific examples thereof, it will be apparent to one skilled in the art that various changes and modifications can be made therein without departing from the spirit and scope thereof.

I claim:

1. A flexible barrier laminate for making packages to preserve oxygen sensitive products by blocking atmospheric oxygen transmission through the flexible barrier laminate, said flexible barrier laminate comprising a single polymer:
a first polymer layer formed of said single polymer;
a second polymer layer formed of said single polymer;
and a first oxygen-barrier layer, said first oxygen-barrier layer being water-soluble and interposed between said first polymer layer and said second polymer layer, said second polymer layer being adhesively secured to said first polymer layer and making up a minimum of approximately 95% by weight of said flexible barrier laminate, said second polymer layer being configured to be separated from said first polymer layer by the application of an aqueous wash to said flexible barrier laminate to cause said first oxygen-barrier layer to dissolve.

2. The flexible barrier laminate of claim 1, wherein said first polymer layer comprises oriented polyethylene.

3. The flexible barrier laminate of claim 1, wherein said first polymer layer is oriented and said second polymer layer is unoriented.

4. The flexible barrier laminate of claim 2, wherein said first polymer layer is oriented and said second polymer layer is unoriented

5. The flexible barrier laminate of claim 1, wherein said first oxygen-barrier layer is polyvinyl alcohol.

6. The flexible barrier laminate of claim 1, wherein said second polymer layer is adhesively secured to said first polymer layer by a an adhesive material layer interposed between said first polymer layer and said second polymer layer, wherein said first oxygen-barrier layer is interposed between said first polymer layer and said adhesive material layer, and wherein a second oxygen-barrier layer is interposed between said adhesive material layer and said second polymer layer, said second oxygen-barrier layer being water-soluble.

7. The flexible barrier laminate of claim 2, wherein said second polymer layer is adhesively secured to said first polymer layer by a an adhesive material layer interposed between said first polymer layer and said second polymer layer, wherein said first oxygen-barrier layer is interposed between said first polymer layer and said adhesive material layer, and wherein a second oxygen-barrier layer is interposed between said adhesive material layer and said second polymer layer, said second oxygen-barrier layer being water-soluble.

8. The flexible barrier laminate of claim 6, wherein said first oxygen-barrier layer is polyvinyl alcohol and said second oxygen-barrier layer is polyvinyl alcohol.

9. The flexible barrier of claim 6, wherein said adhesive material layer comprises polyester-urethane adhesive.

10. The flexible barrier laminate of claim 3, additionally comprising a layer of printing ink between said first polymer layer and said second polymer layer.

11. The flexible barrier laminate of claim 6, additionally comprising a layer of printing ink between said first layer and said second layer.

12. The flexible barrier laminate of claim 8, wherein said first polymer layer is polyethylene and is approximately 25 microns in thickness, and wherein said second polymer layer is polyethylene and is approximately 75 microns in thickness, and wherein said first and second layers of polyvinyl alcohol are each 0.5 microns in thickness.

13. The flexible barrier laminate of claim 1, wherein said flexible barrier laminate forms the body of a flexible package, said flexible package having an interior chamber configured to hold an oxygen sensitive product therein.

14. The flexible package of claim 13, wherein said body includes a mouth formed by abutting portions of said flexible barrier laminate, said mouth including a peelable seal material layer interposed between said abutting portions of said flexible barrier laminate, whereupon said mouth is configured to be peeled open to provide access to the oxygen sensitive product within said interior chamber.

15. The flexible barrier laminate of claim 14, wherein said first polymer layer is polyethylene and is approximately 25 microns in thickness, and wherein said second polymer layer is polyethylene and is approximately 75 microns in thickness, wherein said first and second layers of polyvinyl alcohol are each 0.5 microns in thickness, and wherein said peelable seal material is approximately 2 microns in thickness.

16. The flexible package of claim 1, wherein said flexible barrier laminate additionally comprising a layer of aluminum.

17. The flexible package of claim 6, wherein said flexible barrier laminate additionally comprising a layer of aluminum.

18. The flexible package of claim 13, additionally comprising a degassing valve mounted on said body of said flexible package and in fluid communication with said interior chamber.

19. A method of recyclable a flexible package, said method comprising:
providing a discarded flexible package having a hollow body resistant to atmospheric oxygen transmission therethrough, said hollow body being formed of a flexible laminated barrier comprising a first polymer layer formed of said single polymer, a second polymer layer formed of said single polymer, and a first oxygen-barrier layer, said first oxygen-barrier layer being water-soluble and interposed between said first polymer layer and said second polymer layer, said second polymer layer being adhesively secured to said first polymer layer and making up a minimum of approximately 95% by weight of said flexible barrier laminate, said second polymer layer being configured to be separated from said first polymer layer by the application of an aqueous wash to said first oxygen-barrier layer;
shredding said discarded flexible package into shredded pieces of said flexible barrier laminate;
subjecting said shredded pieces to an aqueous wash, whereupon said aqueous wash dissolves said oxygen-barrier layer, thereby producing pieces of said first polymer layer and pieces of said second polymer layer;
recovering said pieces of said first polymer layer and second polymer layer from said aqueous wash and from any other materials of said discarded flexible package that may result from the action of said aqueous wash on said shredded pieces.

20. The method of claim 19, wherein said flexible laminated barrier includes a layer of an adhesive.

21. The method of claim 20, wherein said flexible laminated barrier includes at least one of a layer of a printing ink and a layer of aluminum.

22. The method of claim 19, wherein said first polymer material comprises polyethylene.

23. The method of claim 19, wherein said oxygen-barrier layer comprises polyvinyl alcohol.

24. The method of claim 22, wherein said oxygen-barrier layer comprises polyvinyl alcohol.

25. The method of claim 24, wherein said laminated barrier additionally comprises an adhesive.

26. The method of claim 25, wherein said laminated barrier additionally comprises at least one of a printing ink and a layer of aluminum.

27. The method of claim 26, wherein said adhesive comprises polyester-urethane.
